(19) United States
(12) Patent Application Publication
(10) Pub. No.: US 2018/0131042 A1
(43) Pub. Date: May 10, 2018

(54) FILM EXTERIOR BODY FOR BATTERIES, AND BATTERY HAVING SAME

(71) Applicant: Panasonic Intellectual Property Management Co. Ltd., Osaka-shi, Osaka (JP)

(72) Inventors: Tomohiro UEDA, Osaka (JP); Yuya ASANO, Osaka (JP); Yoko SANO, Osaka (JP)

(21) Appl. No.: 15/564,365

(22) PCT Filed: Feb. 25, 2016
(86) PCT No.: PCT/JP2016/001006

§ 371 Date: Oct. 4, 2017

(30) Foreign Application Priority Data
May 29, 2015 (JP) 2015-110466

(51) Int. Cl. H01M 10/34

(52) U.S. Cl. CPC H01M 10/34

(57) ABSTRACT

In a battery including an electrode assembly including a positive electrode, a negative electrode, and an electrolyte layer interposed therebetween, and an exterior body, configured to hermetically house the electrode assembly, a film exterior body for a battery is used. The film exterior body for a battery includes a gas barrier layer, and a seal layer that is stacked on one surface of the gas barrier layer and includes a first resin. The gas barrier layer includes a first metal layer having a Young's modulus of 65×10⁹ N/m² or less, and a thickness T₁ of the first metal layer is more than 5 μm and 200 μm or less.

### TECHNICAL FIELD

The present invention relates to a flexible film exterior body for batteries.

### BACKGROUND ART

In recent years, flexible batteries have been used as power sources for small electronic equipment such as cellular phones, voice recording and playing-back devices, wristwatches, video and still cameras, liquid crystal displays, electronic calculators, IC cards, temperature sensors, hearing aids pressure-sensitive buzzers, and biological wearable devices. For a case or an exterior body of a flexible battery, a film including a gas barrier layer is used. The gas barrier layer suppresses entering of outside air components into the inside of the battery (Patent Literature 1).

As materials for the gas barrier layer, metals such as aluminum, and oxides such as aluminum oxide are suitable. A thickness of the gas barrier layer is desirably thin from the viewpoint of securing flexibility (see Patent Literatures 2 and 3).

### CITATION LIST

### Patent Literature

### PTL 1: Japanese Patent Application Unexamined Publication No. 2011-185768

### PTL 2: Japanese Patent Application Unexamined Publication No.2001-68074

PTL 3: Japanese Patent Application Unexamined Publication No. No. 2004-342564

### SUMMARY OF THE INVENTION

### Technical Problem

Conventionally, batteries have been required to have some flexibility, but batteries have not been folded. Therefore, batteries have not been required to be deformed such that curvature locally increased. However, with diversification of small equipment, the degree of flexibility required for batteries is increasing. For example, a biological wearable device such as an iontophoretic dermal administration device is becoming thinner to such a degree as about 2 mm or less, and is required to be largely deformed in response to the movement of a living body. When a battery is largely deformed, even when an exterior body is highly flexible, crack occurs in a gas barrier layer, and the gas barrier property may be deteriorated. When a gas barrier layer is formed very thin in order to enhance the flexibility of the exterior body, it is further difficult to prevent cracks.

### Solution to Problem

One aspect of the present invention relates to a film exterior body for a battery including a gas barrier layer, and a seal layer that is stacked on one surface of the gas barrier layer and includes a first resin. The gas barrier layer includes a first metal layer having a Young's modulus of 65×10⁹ N/m² or less, and a thickness T₁ of the first metal layer is more than 5 μm and 200 μm or less.

Another aspect of the present invention relates to a battery including an electrode assembly including a positive electrode, a negative electrode, and an electrolyte layer interposed between the positive electrode and the negative electrode, and the film exterior body for a battery, configured to hermetically house the electrode assembly.

### Advantageous Effect of the Invention

According to the present invention, durability of a gas barrier layer of a film exterior body for a battery is improved.

### BRIEF DESCRIPTION OF THE DRAWINGS

FIG. 1 is a sectional view of a stacked structure of an exterior body in accordance with a first exemplary embodiment of the present invention.

FIG. 2 is a sectional view of a stacked structure of an exterior body in accordance with a second exemplary embodiment of the present invention.

FIG. 3 is a sectional view of a stacked structure of an exterior body in accordance with a third exemplary embodiment of the present invention.

FIG. 4 is a sectional view of a stacked structure of an exterior body in accordance with a fourth exemplary embodiment of the present invention.

FIG. 5 is a partially cut-away plan view of an exterior body of a thin battery in accordance with one exemplary embodiment of the present invention.

FIG. 6 is a sectional view taken on line VI-VI of FIG. 5.

### DETAILED DESCRIPTION OF THE PREFERRED EMBODIMENT

A film exterior body for a battery in accordance with the exemplary embodiment includes a gas barrier layer, and a seal layer that is stacked on one surface of the gas barrier layer and includes a first resin. The gas barrier layer includes a first metal layer having a Young's modulus of 65×10⁹ N/m² or less. When the gas barrier layer includes a first metal layer having a Young's modulus of 65×10⁹ N/m² or less, regardless of the thickness of the gas barrier layer, the durability of the gas barrier layer is largely improved. This is because cracks are not likely to occur in the first metal layer even when a battery is largely deformed. From the viewpoint that an effect of improving the durability of the gas barrier layer is large, and the flexibility of the exterior body is enhanced, the Young's modulus of the first metal layer is preferably 50×10⁹ N/m² or less, and further preferably 30×10⁹ N/m² or less.

From the viewpoint of durability, the thickness T₁ of the first metal layer is more than 5 μm, for example, preferably 5.1 μm or more, more preferably 10 μm or more, further preferably 20 μm or more, and particularly preferably 25 μm or more. This makes it easy to secure the gas barrier property of the gas barrier layer (property of suppressing entering of outside air components into the inside of the battery) and to improve durability. Furthermore, the thickness T₁ of the first metal layer is 200 μm or less, preferably 100 μm or less, and further preferably 85 μm or less. This can allow the film exterior body for batteries to have high flexibility. Note here that a range defined by the upper limit and the lower limit of the thickness T₁ is arbitrary. For example, the thickness T₁ of the first metal layer may be 5.1 μm or more and 100 μm or less, 20 μm or more and 200 μm or less, and 10 μm or more and 100 μm or less. The thickness T₁ of the first metal layer may be selected in consideration of balance of the gas barrier property, flexibility, and durability of the gas barrier layer.

The first metal layer includes a first metal having a Young's modulus of 65×10⁹ N/m² or less. Examples of the first metal include tin (Sn), indium (In), magnesium (Mg), bismuth (Bi), cadmium (Cd), calcium (Ca), and the like. From the viewpoint of obtaining a more flexible and more durable first metal layer, the first metal is preferably at least one selected from the group consisting of tin, indium, and magnesium. The first metals may form an alloy.

The first metal layer may include an alloy including the first metal, and a metal other than the first metal (second metal) and/or a semimetal. However, from the viewpoint of reducing the Young's modulus of the first metal layer, the content of the first metal layer contained in the first metal layer is preferably 60 mass % or more.

Examples of the second metal include titanium (Ti), aluminum (Al), nickel (Ni), cobalt (Co), iron (Fe), manganese (Mn), zinc (Zn), lead (Pb), vanadium (V), platinum (Pt), gold (Au), silver (Ag), copper (Cu), palladium (Pd), gallium (Ga), and the like. Furthermore, examples of the semimetal include phosphorus (P), silicon (Si), germanium (Ge), boron (B), antimony (Sb), and the like. Only one of them may be included in the first metal layer, and two or more of them may be included.

The thickness T₁ of the first metal layer is preferably 80% or more, more preferably 90% or more, and may be 100% with respect to the thickness T₀ of the gas barrier layer. When the thickness of the first metal layer occupies 80% or more of the thickness of the gas barrier layer, the overall flexibility of the gas barrier layer is easily secured. Thus, it becomes easy to improve the durability of the gas barrier layer.

The first metal layer may include a plurality of layers each having a Young's modulus of 65×10⁹ N/m² or less. For example, the first metal layer may include at least two layers of a layer containing 90 mass % or more of tin, a layer containing 90 mass % or more of indium, and a layer containing 90 mass % or more of magnesium.

The Young's modulus is a physical property value uniquely defined by types of metals. On the other hand, the Young's modulus of the first metal layer is defined by types and compositions of metals forming the first metal layer. The Young's modulus of the first metal layer is calculated from the following formula, when the first metal layer includes n types of metals (n is an integer of one or more), and the Young's moduli of n types of metals are respectively E(j)N/m² (j is an integer of one or more and n or less), and the rates of n types of metals occupied in the first metal layer are respectively X(j) volume % (j is an integer of one or more and n or less).

E1=ΣE(j)·X(j)/100

The gas barrier layer may further include a metal (or semimetal) oxide layer formed on at least one surface of the first metal layer. The metal oxide layer can impart chemical resistance (for example, acid resistance) to the gas barrier layer. Examples of metals constituting the metal oxide layer include chromium (Cr), aluminum (Al), silicon (Si), magnesium (Mg), cerium (Ce), titanium (Ti), molybdenum (Mo), tungsten (W), zirconium (Zr), and the like. However, from the viewpoint of securing the flexibility of the exterior body, a thickness T₃ of the metal oxide layer is desirably less than 20% and less than 10% of a thickness T₂ of the gas barrier layer,. More specifically, the thickness T₃ is preferably 0.01 to 40 μm, and further preferably 0.05 to 20 μm. Inside the non-aqueous electrolyte battery, a strong acid substance may be generated. Therefore, among the metal oxide layers, a chromium oxide (chromate) layer having high acid resistance.

The gas barrier layer may further include a second metal layer having a Young's modulus of more than 65×10⁹ N/m². However, the thickness T₂ of the second metal layer is desirably less than 20% and more desirably less than 10% with respect to the thickness T₀ of the gas barrier layer. This makes it possible to maintain high flexibility of the gas barrier layer and to allow the gas barrier layer to have various functions. The second metal layer may include a plurality of layers each having a Young's modulus of more than 65×10⁹ N/m². Furthermore, one second metal layer (which may include a plurality of layers) may be provided such that it is stacked only one surface of the first metal layer, and two second metal layers may be provided such that they are stacked on both surfaces of the first metal layer.

The first metal layer is preferably a rolled metal foil. This further makes it easy to secure high gas barrier property of the gas barrier layer, and to improve the durability of the gas barrier layer.

The first resin preferably includes polyolefin. Since the seal layer is brought into contact with a power-generating element (for example, an electrolyte) of a battery, the seal layer is required to have chemical resistance. Including polyolefin in the first resin enables the seal layer to have chemical resistance, and a film exterior body for batteries to be attached by thermal welding of the seal layer.

The film exterior body for batteries may further be provided with a protective layer stacked on the other surface of the gas barrier layer and containing a second resin. Thus, the durability of the film exterior body for batteries can further be improved.

It is preferable that the second resin includes at least one selected from the group consisting of polyolefin, polyamide and polyester. Thus, the chemical resistance of the film exterior body for batteries is improved and the mechanical strength is also improved.

Next, a battery in accordance with the exemplary embodiment of the present invention includes an electrode assembly including a positive electrode, a negative electrode, and an electrolyte layer interposed between the positive electrode and the negative electrode, and the above-mentioned film exterior body for batteries configured to hermetically house the electrode assembly. Such a battery can be allowed to have flexibility. The battery may be a primary battery or a secondary battery. Furthermore, the battery may be a non-aqueous electrolyte battery, or an aqueous electrolyte solution battery.

The electrode assembly may be a sheet-like stack in which a sheet-like positive electrode, a sheet-like negative electrode, and an electrolyte layer are stacked on each other. Such a stack can be formed thinly. Therefore, the total thickness of the electrode assembly and the film exterior body for batteries can be, for example, 2 mm or less, and can also be 1 mm or less. Thus, a flexible battery having high flexibility can be provided.

Hereinafter, preferable exemplary embodiments of the present invention are described in more detail with reference to drawings. However, the present invention is not construed to be limited to the following exemplary embodiments.

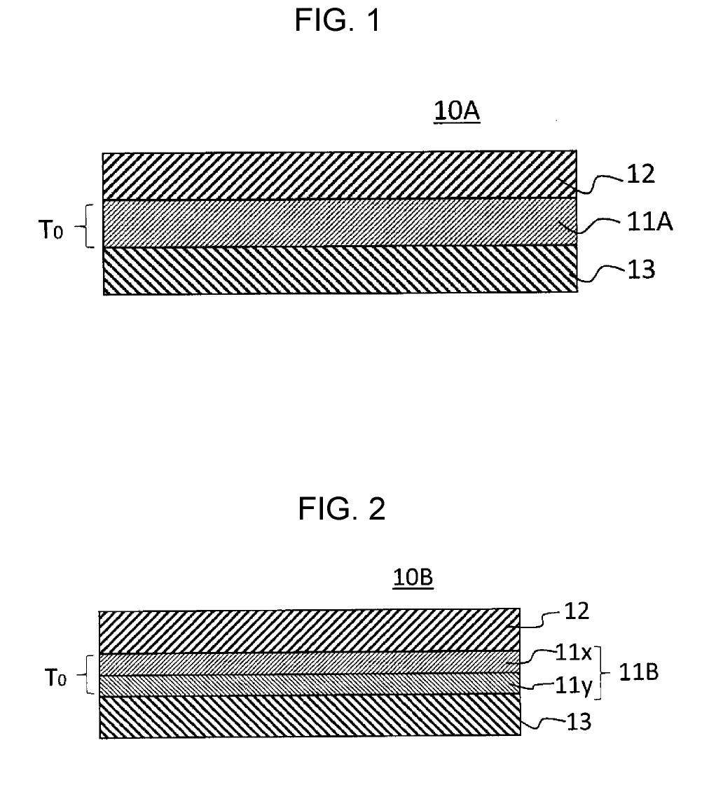

FIG. 1 is a sectional view showing a stacked structure of a film exterior body for batteries (hereinafter, referred to as “exterior body”) in accordance with a first exemplary embodiment of the present invention.

Exterior body 10A includes gas barrier layer 11A formed of a single-layered first metal layer, seal layer 12 stacked on one surface of gas barrier layer 11A, and protective layer 13 stacked on the other surface of gas barrier layer 11A. In this case, a thickness To of gas barrier layer 11A is the same as the thickness T₁ of the first metal layer.

The single-layer first metal layer includes a first metal having a Young's modulus of 65×10⁹ N/m² or less. However, the first metal layer may include a second metal and/or semimetal having a Young's modulus of more than 65×10⁹ N/m² as an alloy component in a range that the Young's modulus of the first metal layer is in a range of 65×10⁹ N/m² or less. The single-layer first metal layer is formed of, for example, a simple substance of the first metal, an alloy of first metals, an alloy of a first metal and a second metal (and/or semimetal), and the like.

FIG. 2 is a sectional view showing a stacked structure of an exterior body in accordance with a second exemplary embodiment of the present invention. Gas barrier layer 11B of exterior body 10B in accordance with the second exemplary embodiment includes a plurality of layers 11x and 11y each having a Young's modulus of 65×10⁹ N/m² or less. An example of the drawing shows a two-layered structure but the first metal layer may have three layers or more. A thickness of each of the layers constituting first metal layer 11B is not particularly limited, but the total thickness is preferably in the range of the T₁ mentioned above.

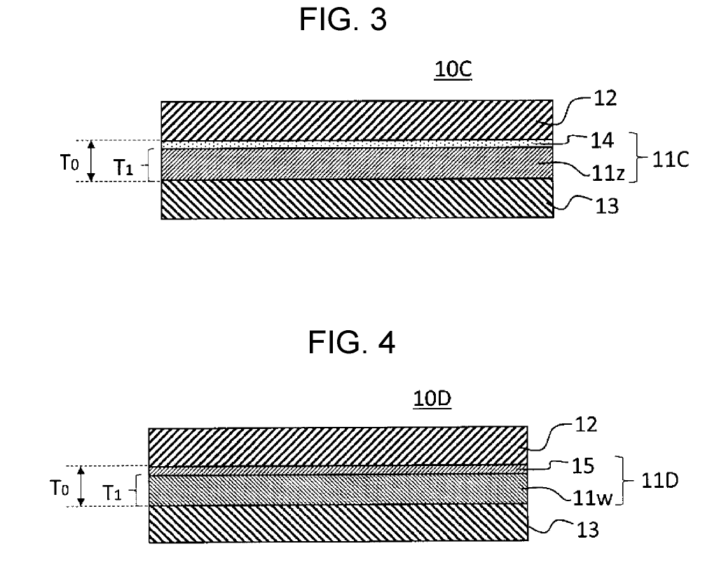

FIG. 3 is a sectional view showing a stacked structure of exterior body 10C in accordance with a third exemplary embodiment of the present invention. Gas barrier layer 11C of exterior body 10C in accordance with the third exemplary embodiment includes first metal layer 11z having a Young's modulus of 65×10⁹ N/m² or less and metal oxide layer 14 that covers first metal layer 11z. In an example of the drawing, first metal layer 11z has a single layer, but first metal layer 11z may include two or more layers each having a Young's modulus of 65×10⁹ N/m² or less.

FIG. 4 is a sectional view showing a stacked structure of exterior body 10D in accordance with a fourth exemplary embodiment of the present invention. Gas barrier layer 11D of exterior body 10D in accordance with the fourth exemplary embodiment includes first metal layer 11w having a Young's modulus of 65×10⁹ N/m² or less, and second metal layer 15 that covers first metal layer 11w. In an example of the drawing, first metal layer 11w has a single layer, but first metal layer 11w may include two or more layers each having a Young's modulus of 65×10⁹ N/m² or less. Similarly, in an example of the drawing, second metal layer 15 is a single layer, but second metal layer 15 may include two or more layers each having a Young's modulus of more than 65×10⁹ N/m². Furthermore, a metal oxide layer may be formed on a surface of first metal layer 11w that is not brought into contact with second metal layer 15, and a metal oxide layer may be formed on second metal layer 15 that is not brought into contact with first metal layer 11w.

In the exterior body in accordance with the first to fourth exemplary embodiments, seal layer 12 includes a first resin, and protective layer 13 includes a second resin. Note here that examples of the exterior body shown in the first to fourth exemplary embodiments include protective layer 13, but protective layer 13 is not necessarily needed.

The first resin and second resin are not particularly limited, and examples thereof include: a polyolefin such as polyethylene (PE) or polypropylene (PP); a polyester such as polyethylene terephthalate (PET), polybutylene terephthalate (PBT); a polyamide (PA) such as polyamide 6, polyamide 11, polyamide 12, polyamide 46, polyamide 9T, or polyamide 66; polyurethane; a polyethylene-vinyl acetate copolymer (EVA); or denatured products thereof. Among them, the first resin preferably includes polyolefin from the viewpoint of excellent thermal welding property. It is preferable that 90 mass % or more of seal layer 13 is polyolefin. On the other hand, the second resin preferably includes at least one selected from the group consisting of polyolefin, polyamide and polyester from the viewpoint of excellent chemical resistance and/or mechanical strength.

Thicknesses of seal layer 12 and protective layer 13 may respectively be, for example, 10 μm to 100 μm, and preferably 15 μm to 80 μm. This makes it possible to secure flexibility of the exterior body, and makes it easy to sufficiently secure the friction resistance, gas barrier property, tensile strength, and the like.

Seal layer 12 and protective layer 13 may have a single layer, or may include two layers or more, respectively. For example, seal layer 12 may have a PP/PET double-layered structure, a PE/PA double-layered structure, an EVA/PE double-layered structure, and the like. Furthermore, protective layer 13 may be a PE/PET double-layered structure.

The film exterior body for batteries can be obtained by forming, for example, a gas barrier layer on one surface of the seal layer. A surface of the gas barrier layer that is not brought into contact with the seal layer may be covered with a protective layer. Thus, an exterior body having a three-layered structure consisting of seal layer/gas barrier layer/protective layer can be formed. Alternatively, a gas barrier layer is formed on one surface of a protective layer, and then a surface of the gas barrier layer that is not in contact with the protective layer may be covered with a seal layer.

The gas barrier layer and the metal oxide layer can be formed by, for example, a gas phase method. Examples of the gas phase method include a vapor deposition method, a sputtering method, an ion-plating method, and the like. The gas phase method is suitable for forming relatively thin metal deposited film and/or metal oxide layer.

When a gas barrier layer having a thickness of more than 5 μm, or 10 μm or more, or 20 μm or more is formed, it is desirable that the gas barrier layer be formed by attaching a metal foil on one surface of the seal layer. For example, a film including a first resin as a seal layer and a metal foil as a gas barrier layer are overlaid on each other, and the both layers are heated and pressurized using a roller and the like, so that the both layers can be joined to each other. Alternatively, a film including a first resin as a seal layer and a film including a second resin as a protective layer stacked on each other with a metal foil as a gas barrier layer sandwiched therebetween. When these three layers are heated and pressurized similar to the above, they can be joined to each other. The metal foil as the gas barrier layer may be an electrolytic metal foil or a rolled metal foil.

The gas barrier layer may be formed by combining an electrolytic metal foil and/or a rolled metal foil and a deposited film formed by the gas phase method. For example, a rolled metal foil as a part of the first metal layer, and a part of the first metal layer and/or a deposited film as the second metal layer are deposited to each other to form a gas barrier layer. However, from the viewpoint of improving the gas barrier property and the durability of the gas barrier layer, it is preferable that at least a first metal layer includes a rolled metal foil. As the rolled metal foil, from the viewpoint of excellent processability, a rolled tin foil is preferable.

The thickness of the film exterior body for batteries is, for example, 25 μm to 400 μm, preferably 30 μm to 300 μm, more preferably 40 μm to 260 μm, and particularly preferably 50 μm to 200 μm. This makes it easy to obtain an exterior body that is excellent in mechanical strength and gas barrier property, and to achieve both flexibility and durability.

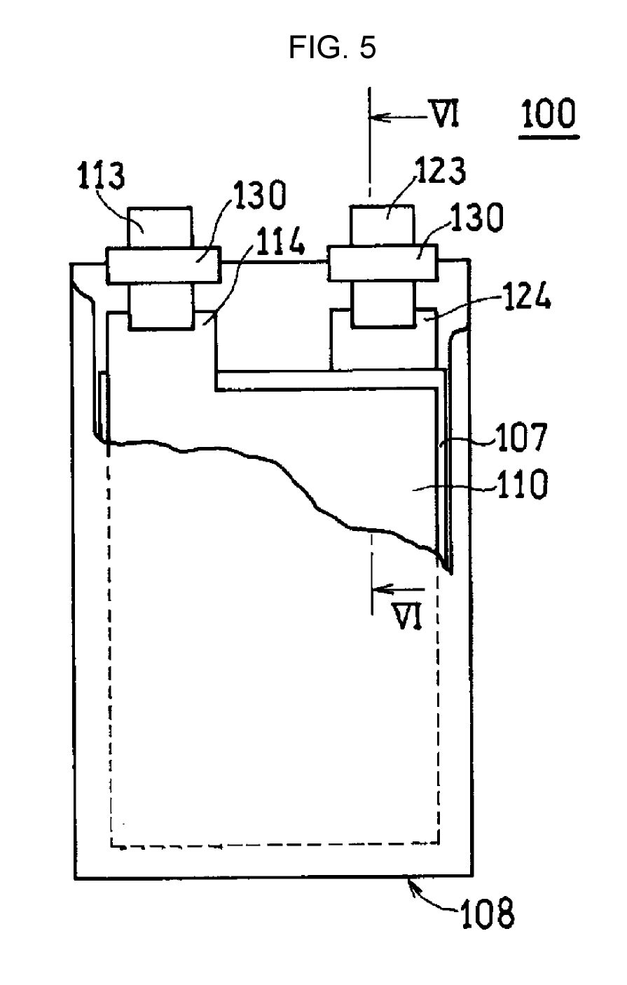

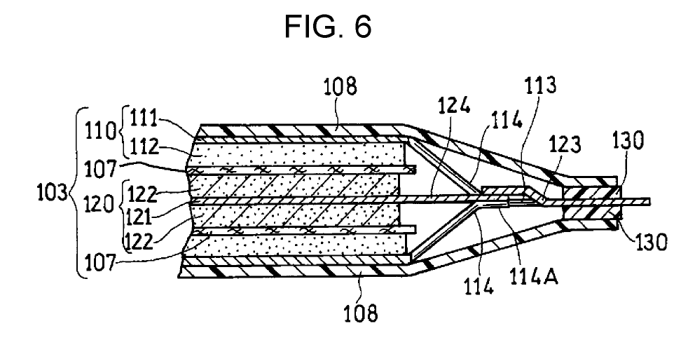

Next, an example of a battery including the above-mentioned film exterior body for batteries is described. FIG. 5 is a partially cut-away plan view of an exterior body of a thin battery in accordance with this exemplary embodiment of the present invention. FIG. 6 is a sectional view of the thin battery taken on line VI-VI of FIG. 5.

Thin battery 100 includes electrode assembly 103, non-aqueous electrolyte (not shown), and exterior body 108 for housing electrode assembly 103 and the non-aqueous electrolyte. Electrode assembly 103 includes a pair of first electrodes 110 located at the outer side, second electrode 120 disposed between the pair of first electrodes 110, and separators 107 interposed between each first electrode 110 and second electrode 120. First electrode 110 includes first current collector sheet 111 and first active material layer 112 attached to one surface of first current collector sheet 111.

Second electrode 120 includes second current collector sheet 121 and second active material layers 122 attached to both surfaces of second current collector sheet 121. The pair of first electrodes 110 are disposed with second electrode 120 sandwiched therebetween such that first active material layer 112 and second active material layer 122 face each other with separator 107 interposed therebetween.

First tab 114 extends from one side of first current collector sheet 111. First tab 114 is cut out from the same conductive sheet material as that of first current collector sheet 111. First tabs 114 of the pair of first electrodes 110 are overlaid on each other and electrically connected to each other by, for example, welding. Thus, assembly tab 114A is formed. First lead 113 is connected to assembly tab 114A. First lead 113 is led out to the outside of exterior body 108.

Similarly, second tab 124 extends from one side of second current collector sheet 121. Second tab 124 is cut out from the same conductive sheet material as that of second current collector sheet 121. Second lead 123 is connected to second tab 124, and second lead 123 is led out to the outside of exterior body 108.

End portions of first lead 113 and second lead 123 derived to the outside of exterior body 108 function as positive electrode outside terminal or negative electrode outside terminal, respectively. It is desirable that seal material 130 for enhancing sealing property be provided between exterior body 108 and each lead. For seal material 130, a thermoplastic resin can be used.

In an example shown in the drawing, the electrode assembly is generally shown in a rectangular shape, but the shape of the electrode assembly is not limited to this shape. From the viewpoint of productivity of thin batteries, a rectangular shape or a substantially rectangular shape is preferable. When the electrode assembly has a rectangular shape or a substantially rectangular shape, the length ratio of the long side to the short side satisfies, for example, long side:short side=1:1 to 8:1. Also, the number and structure of positive electrodes and negative electrodes included in the electrode assembly are not particularly limited.

A method for manufacturing thin battery 100 is not particularly limited, and for example, battery 100 can be produced by the following procedure. Firstly, belt-shaped exterior body 108 is prepared, belt-shaped exterior body 108 is folded into two with a seal layer facing the inner side, and both ends of the belt-shaped exterior body 108 are overlaid on each other and welded, to form a pipe shape. Next, an electrode assembly is inserted from one opening of pipe-shaped exterior body 108, and then the opening is closed by thermal welding. At the time, the end portions of first lead 113 and second lead 123 are derived from one opening of the pipe-shaped exterior body, and seal material 130 is interposed between the opening end portion and each lead. Thus, exterior body 108 is formed into an envelope-shape or a bag-shape. Next, an electrolyte is injected from a remaining part of the opening of envelope-shaped exterior body 108, then, the remaining part of the opening is closed by thermal welding in a reduced pressure atmosphere. Thus, a thin battery is completed.

Next, main principal members constituting an electrode assembly, electrolyte, and the like, are described taking a case where a thin battery is a lithium ion secondary battery as an example.

### Negative Electrode

A negative electrode includes a negative electrode current collector sheet as a first or second current collector sheet, and a negative electrode active material layer as a first or second active material layer. For the negative electrode current collector sheet, a metal film, a metal foil, and the like, are used. It is preferable that a material of the negative electrode current collector sheet is at least one selected from the group consisting of copper, nickel, titanium, an alloy thereof, and stainless steel. The thickness of the negative electrode current collector sheet is, for example, 5 to 30 μm.

The negative electrode active material layer includes a negative electrode active material, and includes a binder and a conductive agent if necessary. The negative electrode active material layer may be a deposited film formed by gas-phase deposition (for example, vapor deposition). Examples of the negative electrode active material include Li metal, metal or an alloy that electrochemically reacts with Li, a carbon material (for example, graphite), a silicon alloy, silicon oxide, and the like. The thickness of the negative electrode active material layer is, for example, 1 to 300 μm.

### Positive Electrode

A positive electrode includes a positive electrode current collector sheet as a first or second current collector sheet, and a positive electrode active material layer as the first or second active material layer. For the positive electrode current collector sheet, a metal film, a metal foil, and the like, are used. It is preferable that a material of the positive electrode current collector sheet is, for example, at least one selected from the group consisting of silver, nickel, palladium, gold, platinum, aluminum, and an alloy thereof, and stainless steel. The thickness of the positive electrode current collector sheet is preferably, for example, 1 to 30 μm.

The positive electrode active material layer includes a positive electrode active material and a binder, and a conductive agent, if necessary. The positive electrode active material is not particularly limited, and a lithium-containing composite oxide such as LiCoO₂ and LiNiO₂ can be used. The thickness of the positive electrode active material layer is preferably, for example, 1 to 300 μm.

Examples of the conductive agent to be contained in the active material layer include graphite and carbon black, and the like. An amount of the conductive agent is, for example, 0 to 20 parts by mass with respect to 100 parts by mass of the active material. Examples of the binder to be contained in the active material layer include fluorocarbon resins, acrylic resins, rubber particles, and the like. An amount of the binder is, for example, 0.5 to 15 parts by mass with respect to 100 parts by mass of the active material.

### Separator

For the separator, a resin microporous film or non-woven fabric is preferably used. Preferable examples of materials (resin) for the separator include polyolefin, polyamides, polyamide-imide, or the like. The thickness of the separator is, for example, 8 to 30 μm.

### Electrolyte

A non-aqueous electrolyte including lithium salt and a non-aqueous solvent for dissolving lithium salt is preferably. Examples of the lithium salt include LiClO₄, LiBF₄, LiPF₆, LiCF₃SO₃, LiCF₃CO₂, imide salts, and the like. Examples of the non-aqueous solvent include cyclic carbonic acid esters such as propylene carbonate, ethylene carbonate, and butylene carbonate; chain carbonic acid esters such as diethyl carbonate, ethyl methyl carbonate, and dimethyl carbonate; and cyclic carboxylic acid esters such as γ-butyrolactone and γ-valerolactone.

It is preferable that at least a part of a non-aqueous electrolyte with which the electrode assembly is impregnated forms a gel electrolyte. The gel electrolyte includes, for example, a non-aqueous electrolyte and a resin swollen with a non-aqueous electrolyte. As the resin swollen with a non-aqueous electrolyte, a fluorocarbon resin including a polyvinylidene fluoride unit is preferable. The fluorocarbon resin including a polyvinylidene fluoride unit easily retains a non-aqueous electrolyte and is easily gelled.

Hereinafter, the present invention is described in more detail with reference to Examples. However, the present invention is not construed to be limited to Examples.

### EXAMPLE 1

A thin battery including a pair of negative electrodes and a positive electrode sandwiched between the negative electrodes was produced by the following procedures.

### (1) Production of Negative Electrode

For a negative electrode current collector sheet, an 8 μm-thick electrolytic copper foil was prepared. Negative electrode mixture slurry was applied to one surface of the electrolytic copper foil, dried, and rolled to form a negative electrode active material layer. Thus, a negative electrode sheet was obtained. The negative electrode mixture slurry was prepared by mixing 100 parts by mass of graphite (average particle diameter: 22 μm) as the negative electrode active material, 8 parts by mass of polyvinylidene-fluoride as the binder, and an appropriate amount of N-methyl-2-pyrrolidone (NMP) with each other. The thickness of the negative electrode active material layer was 145 μm. A 23 mm×55 mm negative electrode having 5 mm×5 mm negative electrode tab was cut out from the negative electrode sheet, and an active material layer was peeled off from the negative electrode tab to expose the copper foil. Thereafter, a negative electrode lead made of copper was ultrasonically welded to a tip end of the negative electrode tab.

### (2) Production of Positive Electrode

For a positive electrode current collector sheet, a 15 μm-thick aluminum foil was prepared. Positive electrode mixture slurry was applied to both surfaces of the aluminum foil, dried, and rolled to form a positive electrode active material layer. Thus, a positive electrode sheet was obtained. The positive electrode mixture slurry was prepared by mixing 100 parts by mass of LiNi_{0.8}Co_{0.16}Al_{0.4}O₂ (average particle diameter: 20 μm) as a positive electrode active material, 0.75 parts by mass of acetylene black as the conductive agent, 0.75 parts by mass of polyvinylidene fluoride as the binder, and an appropriate amount of NMP. A thickness of the positive electrode active material layer for each surface was 80 μm. A 21 mm×53 mm positive electrode having a 5 mm×5 mm tab was cut out from the positive electrode sheet, and an active material layer was peeled off from the positive electrode tab to expose the aluminum foil. Thereafter, a positive electrode lead made of aluminum was ultrasonically welded to a tip end of a positive electrode tab.

### (3) Non-aqueous Electrolyte

A non-aqueous electrolyte was prepared by dissolving LiPF₆ in a mixed solvent of ethylene carbonate (EC), ethyl methyl carbonate (EMC) and diethyl carbonate (DEC) (volume ratio of 20:30:50) at a concentration of 1 mol/L.

### (4) Production of Exterior Body

A rolled tin alloy foil (thickness: 5.1 μm) as gas barrier layer (first metal layer) was overlaid on one surface of a PP film (thickness: 30 μm) as a seal layer, and the both were heated and rolled to obtain a double-layered structure. Thereafter, a PET film as a protective layer was overlaid on the rolled tin alloy foil through an adhesion layer, followed by rolling the entire product. Thus, a multi-layer structured exterior body (thickness: 50 μm) was produced. A Young's modulus of the rolled tin alloy foil was 42×10⁹ N/m². Compositions of the tin alloy foil include Sn: 98.5 mass % and Bi: 1.5 mass %.

### (5) Assembling of Thin Battery

To 100 parts by mass of the above-mentioned mixed solvent, 5 parts by mass of polyvinylidene fluoride was dissolved so as to prepare a polymer solution. The polymer solution was applied to both surfaces of the separator made of 23 mm×59 mm microporous polyethylene film (thickness: 9 μm), and then, the solvent was vaporized to form a polyvinylidene fluoride film. The amount of applied polyvinylidene fluoride was 15 g/m². Thereafter, a positive electrode was disposed between the pair of negative electrodes with a separator interposed therebetween. Thus, an electrode assembly was formed.

Next, an electrode assembly was housed in a pipe-shaped exterior body (thickness 50 μm) with the seal layer facing to the inside. The positive electrode lead and the negative electrode lead were derived from one opening of the exterior body, each lead was surrounded by a thermoplastic resin as a seal material. Then, the opening was sealed by thermal welding. Next, the non-aqueous electrolyte was injected into the pipe-shaped exterior body from the other opening, and the other opening was thermally welded in a reduced pressure atmosphere of −650 mmHg. Thereafter, the battery was subjected to aging in an environment at 45° C., and the electrode assembly was impregnated with the non-aqueous electrolyte. Finally, the battery was pressed at a pressure of 0.25 MPa for 30 seconds at 25° C. to produce battery A1 having a thickness of 0.5 mm.

### EXAMPLES 2 TO 7

Exterior bodies were produced in the same manner as in Example 1 except that the thickness of the rolled tin alloy foil was changed to 5.5 μm (Example 2), 10 μm (Example 3), 20 μm (Example 4), 50 μm (Example 5), 100 μm (Example 6) or 200 μm (Example 7). Thin batteries A2 to A7 including these exterior bodies were produced.

### COMPARATIVE EXAMPLE 1

Exterior body was produced in the same manner as in Example 1 except that the thickness of the rolled tin alloy foil was changed to 4.8 μm, and thin battery B1 including this exterior body was produced.

### EXAMPLES 8 TO 14

Exterior bodies having gas barrier layers having different thicknesses were produced in the same manner as in Examples 1 to 7 except that the rolled tin alloy foil was changed to a rolled indium alloy foil (In: 95 mas % and Zn: 5 mass %), respectively, and thin batteries A8 to A14 including the these resulting exterior bodies were produced. A Young's modulus of the rolled indium alloy foil was 15×10⁹ N/m².

### COMPARATIVE EXAMPLE 2

Exterior body was produced in the same manner as in Example 8 except that the thickness of the rolled indium alloy foil was changed to 4.8 μm, and thin battery B2 including this exterior body was produced.

### EXAMPLES 15 TO 21

Exterior bodies having gas barrier layers having different thicknesses were produced in the same manner as in Examples 1 to 7 except that the rolled tin alloy foil was changed to a rolled magnesium alloy foil (Mg: 98.5 mass % and In: 1.5 mass %), and thin batteries A15 to A21 including these exterior bodies were produced. A Young's modulus of the rolled magnesium alloy foil was 64×10⁹ N/m².

### COMPARATIVE EXAMPLE 3

An exterior body was produced in the same manner as in Example 15 except that the thickness of the rolled magnesium alloy foil was changed to 4.8 μm, and thin battery B3 including this exterior body was produced.

### EXAMPLES 22 TO 24

A rolled tin alloy foil was immersed in a chromate processing solution containing trivalent chromate to form a chromium oxide layer having a thickness of 0.2 μm. Exterior bodies were produced in the same manner as in Examples 1, 4, and 6 except that a rolled tin alloy foil containing an chromium oxide layer was used, and thin batteries A22 to A24 including these exterior bodies were produced.

### EXAMPLES 25 TO 27

An exterior body was produced in the same manner as in Example 4 except that a rolled aluminum alloy foil having a thickness of 4 μm, 6 μm 10 μm was interposed between the rolled tin alloy foil and the protective layer, and thin batteries A25 to A27 including these exterior bodies were produced. A Young's modulus of the rolled aluminum alloy foil was 67×10⁹ N/m².

### EXAMPLE 28

An exterior body was produced in the same manner as in Example 4 except that 20 μm-thick magnesium foil having a 2-μm thick tin plating was used instead of a rolled tin alloy foil, and thin battery A28 including this exterior body was produced.

### COMPARATIVE EXAMPLES 4 TO 10

Exterior bodies having gas barrier layers having different thicknesses were produced in the same manner as in Examples 1 to 7 except that the rolled tin alloy foil was changed to a rolled aluminum alloy foil, and thin batteries B4 to B10 including these exterior bodies were produced.

### Evaluation

### Flexibility of Exterior Body

Since flexibility of an exterior body is reflected on easiness in deforming a thin battery, the flexibility of the exterior body is evaluated based on the bend elastic constant of the thin battery. Specifically, according to the measurement method of JIS K7171, the bend elastic constant of the thin battery was measured. As a test piece, a thin battery as it is was set on a support base. A length L between supporting points of the support base was 30 mm, and tip end radius R was 2 mm. An indenter having a tip end radius R or 5 mm was moved at a rate of 100 mm/min to apply a load to a middle part of the test piece.

### Initial Battery Capacity

Battery A was subjected to the following charge and discharge under an environment at 25° C. to obtain initial capacity (C₀).

Herein, the design capacity of thin battery A is 1 C (mAh).

(1) Constant current charge: 0.2 CmA (final voltage: 4.2 V)
(2) Constant voltage charge: 4.2 V (final electric current: 0.05 CmA)
(3) Constant current discharge: 0.5 CmA (final voltage: 2.5 V)
Capacity Retention Rate after Bending Test

A pair of fixing members capable of expanding and contracting were horizontally disposed to face each other. The portions at both ends of the charged battery, which had been closed by thermal welding, were fixed by the fixing members. Then, in an environment at a humidity of 65% and at a temperature of 25° C., a jig having a curved portion whose radius of curvature R was 20 mm was pressed onto the battery, the battery was bent along the curved portion, then the jig was separated from the battery, and the battery regained its original form. This operation was repeated 4,000 times. Thereafter, the thin battery was charged and discharged in the same conditions as mentioned above to obtain discharge capacity (Cₓ) after the bending test. The capacity retention rate was calculated from the obtained discharge capacity Cₓ and initial capacity C₀ based on the following formula.

Capacity retention rate after bending test (%)=(Cx/C₀)×100

Ten batteries were produced for each Example and Comparative

Example, and the batteries were subjected to the tests similarly, respectively. An average value of the capacity retention rates was calculated. Results are shown in Table 1.

TABLE 1

| | | Initial | Capacity | Bend elastic |
|---|---|---|---|---|
| | First metal | capacity | retention rate | constant |
| | layer (μm) | (mAh) | (%) | (MPa) |
| Battery B1 | 4.8 | 100 | 78 | 21 |
| Battery A1 | 5.1 | 100 | 93 | 24 |
| Battery A2 | 5.5 | 100 | 93 | 24 |
| Battery A3 | 10 | 100 | 98 | 28 |
| Battery A4 | 20 | 100 | 98 | 31 |
| Battery A5 | 50 | 100 | 98 | 33 |
| Battery A6 | 100 | 100 | 98 | 36 |
| Battery A7 | 200 | 100 | 98 | 39 |
| Battery B2 | 4.8 | 100 | 71 | 10 |
| Battery A8 | 5.1 | 100 | 93 | 11 |
| Battery A9 | 5.5 | 100 | 93 | 12 |
| Battery A10 | 10 | 100 | 98 | 14 |
| Battery A11 | 20 | 100 | 98 | 15 |
| Battery A12 | 50 | 100 | 98 | 17 |
| Battery A13 | 100 | 100 | 98 | 18 |
| Battery A14 | 200 | 100 | 98 | 22 |
| Battery B3 | 4.8 | 100 | 65 | 22 |
| Battery A15 | 5.1 | 100 | 83 | 25 |
| Battery A16 | 5.5 | 100 | 83 | 25 |
| Battery A17 | 10 | 100 | 86 | 29 |
| Battery A18 | 20 | 100 | 98 | 33 |
| Battery A19 | 50 | 100 | 98 | 36 |
| Battery A20 | 100 | 100 | 98 | 38 |
| Battery A21 | 200 | 100 | 98 | 49 |
| Battery A22 | 5 | 100 | 90 | 21 |
| Battery A23 | 20 | 100 | 98 | 32 |
| Battery A24 | 100 | 100 | 98 | 37 |
| Battery A25 | 20 | 100 | 98 | 160 |
| Battery A26 | 20 | 100 | 98 | 163 |
| Battery A27 | 20 | 100 | 98 | 168 |
| Battery A28 | 20 | 100 | 98 | 32 |
| Battery B4 | 5.1 | 100 | 32 | 85 |
| Battery B5 | 5.5 | 100 | 32 | 85 |
| Battery B6 | 10 | 100 | 41 | 90 |
| Battery B7 | 20 | 100 | 65 | 145 |
| Battery B8 | 50 | 100 | 66 | 210 |
| Battery B9 | 100 | 100 | 59 | 510 |
| Battery B10 | 200 | 100 | 55 | 980 |

As shown in Table 1, in Comparative Examples 1 to 3, since the thickness of the first metal layer was less than 5 μm, the durability of the gas barrier layer is low, and the capacity retention rate is decreased. On the other hand, in Examples 1 to 21 in which the thickness of the first metal layer was more than 5 μm, the capacity retention rate is largely improved, higher capacity retention rate is obtained as compared with Comparative Examples 4 to 10. When the thickness of the gas barrier layer is 20 μm or more, the capacity retention rate is substantially at the same level. In Examples 1 to 21, the bend elastic constant of the battery is small, and it is demonstrated that even when the thickness of the first metal layer becomes 10 μm or more, the flexibility of the exterior body is high. It is considered that the durability of the gas barrier layer is largely improved because the capacity retention rate is largely improved when the thickness of the first metal layer becomes 10 μm or more.

### INDUSTRIAL APPLICABILITY

A film exterior body for batteries of the present invention is used for power source of a small-sized electronic equipment such as a biological wearable device or a wearable portable terminal, and is suitable for an exterior body of a thin battery capable of being largely deformed.

### REFERENCE MARKS IN THE DRAWINGS

10A to 10D exterior body
11A to 11D gas barrier layer
11x, 11y, 11z, 11w first metal layer
12 seal layer
13 protective layer
14 metal oxide layer
15 second metal layer
100 thin battery
103 electrode assembly
107 separator
108 exterior body
110 first electrode
111 first current collector sheet
112 first active material layer
113 first lead
114 first tab
120 second electrode
121 second current collector sheet
122 second active material layer
123 second lead
124 second tab
130 seal material

1. A film exterior body for a battery, comprising:
a gas barrier layer; and
a seal layer that is stacked on one surface of the gas barrier layer, and includes a first resin,
wherein the gas barrier layer includes a first metal layer having a Young's modulus of 65×10⁹ N/m² or less, and a thickness T₁ of the first metal layer is more than 5 μm and 200 μm or less.

2. The film exterior body for a battery according to claim 1, wherein the first metal layer includes at least one selected from the group consisting of tin, indium, and magnesium.

3. The film exterior body for a battery according to claim 1, wherein the thickness T₁ of the first metal layer is 80% or more with respect to a thickness T₀ of the gas barrier layer.

4. The film exterior body for a battery according to claim 1, wherein the gas barrier layer further comprises a metal oxide layer formed on at least one surface of the first metal layer.

5. The film exterior body for a battery according to claim 1, wherein the gas barrier layer further comprises a second metal layer, the second metal layer has a Young's modulus of more than 65×10⁹ N/m², and has a thickness T₂ that is less than 20% with respect to the thickness To of the gas barrier layer.

6. The film exterior body for a battery according to claim 1, wherein the thickness T₁ of the first metal layer is 10 μm or more and 100 μm or less.

7. The film exterior body for a battery according to claim 1, wherein the first metal layer is a rolled metal foil.

8. A battery comprising:
an electrode assembly including a positive electrode, a negative electrode, and an electrolyte layer interposed between the positive electrode and the negative electrode, and
the film exterior body for a battery according to claim 1, configured to hermetically house the electrode assembly.

9. The battery according to claim 8, wherein
the electrode assembly is a sheet-shaped stack including the positive electrode, the negative electrode, and the electrolyte layer that are stacked on each other, wherein the positive electrode and the negative electrode are formed in a sheet shape, respectively, and
a total thickness of the electrode assembly and the film exterior body for a battery is 2 mm or less.
